(19) United States
(12) Patent Application Publication
(10) Pub. No.: US 2023/0191427 A1
(43) Pub. Date: Jun. 22, 2023

(54) A TUNABLE MICROFLUIDIC DIELECTROPHORESIS SORTER

(71) Applicants: THE REGENTS OF THE UNIVERSITY OF CALIFORNIA, Oakland, CA (US); PIONEER HI-BRED INTERNATIONAL, INC., Johnston, IA (US)

(72) Inventors: Mohammad Aghaamoo, Irvine, CA (US); Ronald L. Biro, Clive, IA (US); Kevin Day, Boone, IA (US); Abraham P. Lee, Irvine, CA (US); Edwin Mendez, West Des Moines, IA (US); Pon Samuel, Carmel, IN (US); Justin Schares, Ames, IA (US); Yue Yun, Johnston, IA (US); Braulio Cardenas Benitez, Irvine, CA (US)

(21) Appl. No.: 17/996,168

(22) PCT Filed: Apr. 19, 2021
(86) PCT No.: PCT/US21/27945

§ 371 Date: Oct. 13, 2022

Related U.S. Application Data
(60) Provisional application No. 63/011,426, filed on Apr. 17, 2020.

(51) Int. Cl. B03C 5/00; B01L 3/00; B03C 5/02

(52) U.S. Cl. CPC B03C 5/005; B01L 3/502761; B03C 5/026; B01L 3/502776; B01L 2200/0652; B01L 2400/0424

(57) ABSTRACT

A microfluidic sorting device and method employing dielectrophoresis (DEP) induced field flow separations are described herein. The microfluidic sorting device has a microchannel and an array of electrodes disposed along the microchannel. The electrodes may be oriented at an angle relative to the microchannel. Non-mammalian samples such as plant samples flow in the microchannel and through the electrode array. Current is passed through the electrodes causing a DEP force to be exerted on the samples. This force may generate a torque that causes one type of sample to rotate and slide along the electrodes, thus separating the samples by type. The separated samples are collected in different output channels

### CROSS-REFERENCES TO RELATED APPLICATIONS

This application claims benefit of U.S. Provisional Application No. 63/011,426 filed Apr. 17, 2020, the specification of which is incorporated herein in its entirety by reference.

### BACKGROUND OF THE INVENTION

### Field of the Invention

The present invention relates to microfluidic sorting, in particular, to a microfluidic device that employs dielectrophoresis (DEP) induced field flow separation of biological samples into different types.

A high-throughput system is needed for non-invasively, e.g. without dyes or probes, identifying and separating cells (especially non-mammalian cells such as plant cells) into particular cell groups for various specific downstream purposes including, but not limited to, haploid embryogenesis.

The present invention features sorting of cells based on the difference between dielectric properties of cells in combination with the unique hydrodynamic-DEP force balance they experience.

### BRIEF SUMMARY OF THE INVENTION

It is an objective of the present invention to provide microfluidic devices and methods that implement dielectrophoresis (DEP) sorting, as specified in the independent claims. Embodiments of the invention are given in the dependent claims. Embodiments of the present invention can be freely combined with each other if they are not mutually exclusive.

In some aspects, the present invention features a microfluidic DEP sorting device for sorting cells (especially non-mammalian cells such as plant cells). The individual cells, small clumps, or multicellular structures can be described as particles moving in a laminar flow stream of carrier liquid through a sorting region in the device. Carrier liquid and particles are input on one end of the sorting region through microfluidic channels and output streams (for each desired sorted sub-population) are collected through 2 to several output microfluidics channels on the opposite end of the device.

The device may comprise of a microchannel and a sorting region comprising at least one pair of electrodes, or an array of electrode pairs, disposed in the first microchannel (110). Each electrode is typically a relatively long, narrow, ribbon-like, bar-like, or wire-like metallic structure. Electrode pairs are arranged parallel to each other. Each electrode may be partially covered with a non-stick coating in order to minimize interactions between the electrodes and cells while maintaining a sufficient electric field to sort the plant cells. In some embodiments, the device may operate at 0.5-100, 0.5-10, 10-20, or 20-50 peak-to-peak volts. In some embodiments the device may operate at a frequency of 10 kHz-1.5 MHz, 200-500 kHz, 500-900 kHz, or 600-800 kHz.

In other aspects embodiments, the present invention features a method of sorting at least two types of samples (such as plant samples) using DEP. The samples may comprise a population of individual cells, clumps of cells, and/or multi-cellular structures that act as particles with differing hydrodynamic and electrical properties. The method may comprise providing a microfluidic DEP sorting device comprising a microchannel and a sorting region. A bulk laminar flow of carrier liquid provides the force to load particles, move the particles from one end of the sorting region to the other end, and to collect particles through the output channels. The sorting region contains at least one pair of electrodes, or an array of electrodes, and imposing a rapidly alternating voltage potential (oscillating at a specified frequency) to each pair of electrodes which induces an electrical field between the electrodes. The electrical field can induce movement of particular particles toward or away from the charged electrodes based on the DEP properties of the individual particles.

Without wishing to limit the present invention, two types of device embodiments are demonstrated herein. In both embodiments, the device employs and combines the hydrodynamic force of the flowing carrier liquid with the force generated by the imposed electrical field of the electrodes to drive movement of the particles. In one embodiment (A), a single pair of electrodes are arranged with their long axis in parallel with the direction of bulk flow of carrier liquid through the sorting region. In embodiment A, particles with appropriate DEP properties, relative to the applied frequency and voltage, are input into a laminar flow stream farthest from the electrodes and are attracted to, are unaffected by, or repelled from the electrodes thereby segregating the particles by their DEP properties into different laminar flow streams, either in close proximity to the electrodes or distant from the electrodes. The bulk laminar flow of carrier liquid then carries these segregated particles to output collection channels located in closest proximity to those particular laminar flow streams.

In embodiment (B), 2 or more electrodes are arranged in a herring-bone configuration at an angle (described below) to the bulk flow of carrier liquid through the sorting region. Particles with appropriate DEP properties are attracted to or repelled from the charged electrodes. The angle of the electrodes, the DEP attraction to the electrodes, and the hydrodynamic force of the flowing carrier liquid combine to change the direction of movement of the particles such that the particles roll or slide along the electrodes. Since the angled electrodes intersect with more than one laminar flow stream, this can divert the particles from one laminar flow stream to another thereby segregating those particles by their DEP properties from particles with different DEP properties. The flow rate of the laminar flow carrier liquid, the length and number of electrodes, the spacing of the electrodes in the sorting region, the length and width of the sorting region, and the strength of the attraction of the individual particles to the electrodes determines the degree of segregation possible. The number and size of the output channels then determines and allows for collection of the various streams containing the segregated particles.

At low frequencies (≤1.5 MHz), membrane properties such as membrane capacitance and conductance primarily dictate cell behavior, with capacitance dominating. Based on their DEP characterization, each type of plant cells possesses distinct cross-over frequencies (fₓₒ) and thus, unique dielectric properties. Without wishing to limit the invention to any theory or mechanism, the DEP sorter combines this with the plant cells' unique hydrodynamic response to sort different types of plant cells. None of the presently known prior references or work has the unique inventive technical feature of the present invention.

In some embodiments, the samples (or plant samples) are plant cells comprising microspores, pollen, embryos, or protoplasts. In other embodiments, the samples (or plant samples) are tetrads, single cells, or microcalli. Non-limiting examples of plant cells include cells from corn, soybean, rice, canola, sorghum, cotton, rice, millet (millet being inclusive of pearl millet, Pennisetum glaucum) or wheat.

In some embodiments, the present invention involves characterizing samples (such as plant cells) and tuning the frequency, voltage, and flow rate parameters of the system for specific DEP properties to allow cell selection with specific characteristics for sorting. The samples may be sorted according to their physiological activity, molecular composition, formation, or stage of development. In one embodiment, the samples may be sorted into plant samples with high physiological activity and plant samples with low physiological activity. For example, the two types of plant samples are live and dead plant samples. In another embodiment, the plant samples may be sorted into plant samples with high viability and plant samples with low viability. Further, such terms, when used herein, are mean cells with high levels of metabolic activity or activity indicators (high viability), as versus cells with little or no level of metabolic activity or activity indicators (low viability).

In some other embodiments, the plant samples are differentiated by their cellular structures such as microcalli, tetrads, or single cells. For example, single plant cells may be sorted from microcalli or single plant cells may be sorted from tetrads.

In other embodiments, the plant samples are differentiated by their stage of development. For example, the two types of plant samples are early stage and late stage. In another example, the types of plant samples are uninucleate, binucleate, and multinucleate.

In other embodiments, the length of the flow channel and/or the angle of the electrode grid relative to the direction of carrier flow can be adjusted to improve separation of cells into groups. In other embodiments, the surface of the fluidic channels and/or the electrodes may be coated with non-stick coatings to prevent cell from sticking. Alternatively, or in conjunction, surfactants may be added to the carrier fluid to prevent sticking of cells.

In some embodiments, the DEP device may further include output port flow regulators to help improve flow. The DEP device may also incorporate a DEP AC intervalometer to allow for a pulsed DEP field to prevent clogging. In some other embodiments, the DEP device may integrate a support frame to house the microfluidics chip and simplify operations. In further embodiments, the DEP device can be cleaned and reused multiple times.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows a schematic of a microfluidic dielectrophoresis (DEP) chip of the present invention.

FIG. 2A shows an example of sorting live and dead plant cells using the microfluidic DEP chip.

FIG. 2B shows an example of sorting early and late stage microspores using the microfluidic DEP chip.

FIG. 3 illustrates positioning of electrodes at 30° parallel to the flow direction results in a torque that causes the cells to effectively rotate while moving along the electrodes to facilitates their transport.

FIGS. 4A-4B show non-limiting embodiments of the microfluidic DEP chip with the electrodes coated with a non-stick coating.

FIGS. 5A-5B show schematics of an alternative embodiment of the DEP chip.

FIG. 5C is a schematic of the sorting process at the DEP region of the DEP chip.

FIG. 5D shows a force analysis and electric field distribution in the DEP region.

FIGS. 6A-6C are images of fluorescein diacetate (FDA) stained live and dead microspores. FIG. 6A shows 56% viability with FDA stain of pre-sorted stock microspore sample. FIG. 6B shows 87% viability of FDA stained microspores from output 1 after being sorted using the microfluidic DEP chip of the present invention. FIG. 6C shows 8% viability of FDA stained microspores from output 2 after being sorted using the microfluidic DEP chip. FIGS. 6D-6E show images of a population of fluorescein diacetate (FDA) stained microspores in a chip with DEP field on. Viable cells (FDA) moved towards the electrodes while non-viable cell that did not take the stain and either moved away from the electrodes or did not move at all.

FIGS. 7A-7C show time-lapse images demonstrating the separation of a mixed population of microspores using the microfluidic DEP chip of FIG. 5A. A tetrad flows straight through the device into output 1 (O1) while single microspores are attracted to the electrodes and dragged towards the right side to output 2 (O2).

FIG. 7D shows a viability test using Calcein Blue AM staining on the cell sample collected at each specific outlet as well as the cell sample before the DEP process. The results demonstrate that DEP-based isolation and enrichment does not affect cells' viability.

FIG. 8 shows an image of small early uninucleate microspores that experience relatively strong pDEP force and attract to electrodes and slide towards the left side of the channel towards output 1 while bigger late uninucleate microspores (weak pDEP, no DEP, or nDEP) flow on the right side of the channel towards output 2.

FIG. 9A shows the flow of all cells when the DEP field is off. All cells continue along the flow on the right side of the chip. FIGS. 9B-9D show the middle of the channel with the DEP field on. Viable cells are attracted to the electrodes and migrate to the left side of the chip. Cells not influenced by the DEP field continue the right-side flow of the chip. FIGS. 9E-9H show the outputs of the chip. DEP influenced cells flow out to O1 and non-influenced DEP cell exit to O2.

FIGS. 10A-10B show time-lapse images demonstrating the separation of a mixed population of microspores using a DEP device. FIG. 10A shows a mixed population of responding and non-responding microspores in the DEP channel. FIG. 10B illustrates how responding microspores experience relatively strong pDEP force and attract to electrodes while non-responding microspores either weak pDEP, no DEP, or even nDEP (tend to be repelled from electrodes).

FIG. 11A show a cultured treated population of canola cells composed of multicellular structures, single cells, and non-viable cells in a DEP chip with the field off. FIGS. 11B-11C show time-lapse images demonstrating the separation of multicellular structures moving towards the corner of electrodes while other cell types are not influenced by DEP.

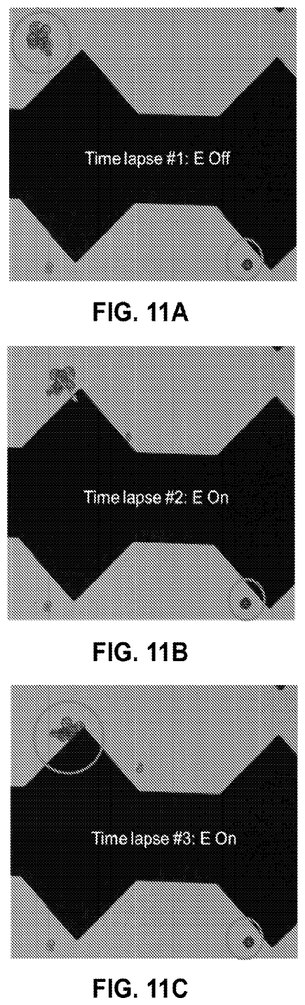

FIG. 12A shows an example of pollen grains experiencing nDEP, showing their repulsion from sharp electrode tips where electric field is strongest (applied signal of 40 Vpp at 20 kHz, in a non-flow device). Pollen grains are concentrated at the center of hexagon structures. FIG. 12B shows an arrangement of pollen grains before (t=0) and after (t>0) application of nDEP signal, illustrating the concentration of pollen grains towards the centers of the hexagon-shaped electrodes.

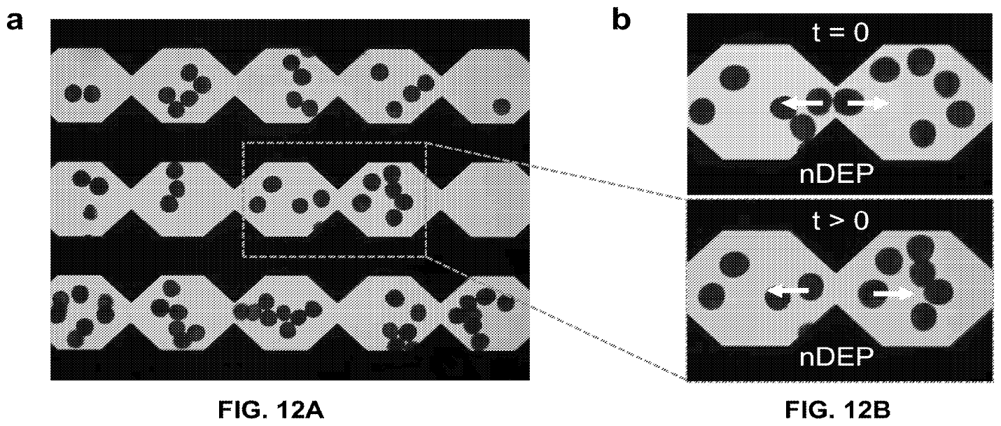

FIG. 13 illustrates pollen germination rate (5 hrs assay), after application of a DEP signal of 20 Vpp for three different frequencies. Error bars indicate standard deviation (n=3). No statistically significant differences were found between controls and samples subject to the DEP signals though a paired two-tailed T-test (p-values of 0.36, 0.23 and 0.13, respectively).

### DETAILED DESCRIPTION OF THE INVENTION

Following is a list of elements corresponding to a particular element referred to herein:

10 plant samples

100 microfluidic dielectrophoresis (DEP) sorting device

111 first microchannel

115 input channel

120 sorting region

125 array of electrodes

126 top surface of electrode

127 top edge of the top

128 side of electrode

129 surface between electrodes

130 coating

135 output channel

As used herein, the microfluidic devices employ fluid volumes on the scale of microliters (10⁻⁶) to femtoliters (10⁻¹⁵) that are contained within sub-millimeter scale channels. The structural or functional features may be dimensioned on the order of mm-scale or less, preferably in the micron scale or less. For example, a width of the channel may range from 500 μm to greater than 1500 μm and a height of the channel may range from 50-300 μm in height. In other embodiments, a length of the channel may range from mm to greater than cm-scale. The microfluidic device may employ active techniques (e.g. micropumps and microvalves) or passive techniques for fluid transport and droplet production.

Samples for Sorting

As used herein, the term “plant” includes reference to whole plants, plant organs (e.g., leaves, stems, roots, etc.), seeds and plant cells and progeny of same. The term “plant cell” refers to single cells, small multicellular structures within a common enveloping cell wall, or small clusters of individual cells (e.g. microcallus or small organized cell embryoids) belonging to or derived from organism members of the plant kingdom. Plant cells are generally characterized as cells containing plastids and capable of producing a cell wall external to the plasma-membrane, as distinguished from “animal cells”. As used herein, plant cells include, without limitation, cells or protoplasts derived from seeds, suspension cultures, embryos, meristematic regions, microcalli, leaves, roots, shoots, gametophytes, sporophytes, plant egg cells, pollen, and microspores. As used herein, the term gametophyte is inclusive of microspores, pollen grains and tetrads.

In some preferred embodiments, the samples to be sorted are plant-based. The plant samples may comprise plant cells. Non-limiting and non-exhaustive examples of plant cells include cells from corn, soybean, wheat, canola, sorghum, rice, sunflower, cotton, grass, flowering plants, fruit-bearing plants, trees, tuberous plants, potatoes, root plants, carrots, peanut, nuts, beans, legumes, and squashes. It is to be understood that plant cells may encompass all species, forms, and stages of plant cells. In other embodiments, the samples to be sorted are non-mammalian samples other than plant cells, such a fungus or bacteria samples).

One of the distinguishing characteristics of many types of plant cells is a cell wall that surrounds a cell membrane to provide strength and structure to the plant cell. In some embodiments, the cell wall may be rigid or have some flexibility, and tend to be sticky. The cell wall may be comprised of polysaccharides including cellulose, hemicellulose, and pectin. In some embodiments, the size of the plant cell may range from about 10 μm to about 150 μm. In other embodiments, the size of the plant cell may be greater than 150 μm.

In some embodiments, the cells used in the present invention may be walled-plant cells. In other embodiments, the cells may be protoplasts, which are intact plant cells that had its cell wall completely or partially removed. In some embodiments, the cell wall can be removed using either mechanical or enzymatic means. Protoplasts are not limited to plant cells, and can include bacterial or fungal cells.

As used herein, a “haploid” is a plant with the gametic or n number of chromosomes. A doubled haploid or doubled haploid plant or cell is one that is developed by doubling of a haploid set of chromosomes (for example, using colchicine or another doubling agent). Plant breeding for a number of crops has been revolutionized by doubled haploid technology, in which haploid plant embryos (or plants produced therefrom) are obtained and then doubled, allowing the rapid production of recombinant lines with favorable gene combinations. Haploid embryos can be produced in vitro using either gynogenesis (embryo culture) or androgenesis (anther and microspore culture)

As used herein, a “microspore” is an individual haploid structure produced from diploid sporogenous cells (e.g., microsporophyte, pollen mother cell, or meiocyte) following meiosis. Examples of microspores include, but are not limited to, maize microspores, canola microspores, and wheat microspores.

As used herein, a “pollen grain” is a mature gametophyte containing vegetative (non-reproductive) cells and a generative (reproductive) cell.

In yet other embodiments, the cells used in the present invention may be a tetrad. The term “tetrad” refers to a single structure comprised of four individual physically attached components, such as microspore tetrad having four individual physically attached microspores or pollen tetrad having four individual physically attached pollen grains.

As used herein, a “microcallus”, and its plural form “microcalli”, refers to a cell cluster arising from a single cell, or a multicellular structure (MCS) derived from individual cells. For example, dividing single cells can form an MCS. In non-limiting embodiments, the microcalli may be microspore-derived MCS or protoplast-derived MCS. In some embodiments, microcalli may be about 0.1 to 1 mm in size. Microcalli can be with and without internal cellular organization (amorphous) and can be maintained in suspension for scaling-up or differentiation into an organoid in vitro.

As used herein, the term “molecular composition” refers to proteins, carbohydrates, lipids, other organic compounds, and/or the ionic material content of a cell or small multi-cellular structure. For the purpose of this patent application, plant cells may be sorted based on molecular composition when there is a chemical difference, including structural and configurational differences, sufficiently large enough to result in a discernible difference in the charge relationship of a cell sub-group to an applied DEP field across a medium, resulting in an observable attractive, repulsive, or neutral force on the cell. The applied DEP field may be non-uniform. The molecules may be internal to the plasma-membrane, may be in the cytoplasm, on or within organelles or plastids, may be part of the plasma-membrane, may be within the cell wall(s), or may be on the surface of the cell wall(s).

In preferred embodiments, the microfluidic channels are sized to accommodate plant samples. For example, a height of the microfluidic channel may be about 200 μm for maize cells. As another example, a height of the microfluidic channel may be about 50 μm for canola cells or 75 μm for soybean cells.

When referring to sorting by type or classification, this includes, but is not limited to, sorting samples, e.g. plant cells, based on physiological activity, molecular composition, formation, or stages of development. Physiological activity refers to cell function or viability of the cell. In some embodiments, physiological activity can range from being dead to being alive or from having low activity to high activity. In other embodiments, the viability of the cell refers to the capability of growing/developing into a plant under the proper growth conditions. Cell viability ranges from having low viability to high viability.

Different formations of the plant cells include microcalli, pollen grain, microspores, tetrad, and protoplast. For instance, the microspores singles and tetrads may be sorted/separated using the device of the present invention.

Different stages of development can refer to early stage and late stage. In one some embodiments, the stages of development include uninucleate (single nucleus), binucleate (two nuclei), and multinucleate (three or more nuclei). In other embodiments, the plant cells are sorted according to size based on their stage of development. For example, smaller-sized early uninucleate cells are separated from larger-sized late uninucleate cells using the device of the present invention.

Dielectrophoresis (DEP) Sorting

DEP is defined as the motion of polarized particles/cells in a non-uniform electric field. Frequency and strength of the applied electric field as well as dielectric properties of cells and medium determine the behavior of plant cells in a non-uniform electric field. Based on the combination of these parameters, three main DEP regimes can be observed:

1. Plant cells experience a so-called negative DEP (nDEP) and are repelled from high electric field regions.

2. Plant cells are attracted toward high electric field regions and thus experience positive DEP (pDEP).

3. At specific applied frequencies, termed cross-over frequencies (fₓₒ), the plant cells experience no induced DEP force due to the transition in their polarity (i.e. from nDEP to pDEP).

Referring now to the figures, in some embodiments, the present invention features a microfluidic DEP sorting device (100) for sorting cells such as plant cells. The device (100) may comprise a first microchannel (110), and a sorting region (120) comprising at least one array of electrodes (125) disposed in the first microchannel (110). In preferred embodiments, each electrode (125) is partially covered with a non-stick coating (130) in order to minimize interactions between the electrodes and cells while maintaining a sufficient electric field to sort the cells. In other embodiments, a surface (129) between neighboring electrodes is optionally covered with the non-stick coating (130).

According to some embodiments, the present invention features a method of sorting at least two types of samples (10) such as plant samples using DEP. In other embodiments, the present invention features a non-invasive method of sorting non-mammalian samples, such as pollen, microspores, plant cells, or other non-mammalian cells. The method may comprise providing a microfluidic sorting device (100) comprising a first microchannel (110) and a sorting region (120) comprising at least one array of electrodes (125), flowing the samples (10) in the first microchannel (110) such that the samples (10) flow in a first flow stream, and passing current through the electrodes (125).

While DEP sorting is known to work for certain mammalian cells, it is surprising that DEP may also be used to sort non-mammalian cells such as plant cells. This is because of the structural differences between mammalian cells and non-mammalian cells. For example, plant cells have cell walls, which may hinder the cells from responding to electric fields which cause a DEP response in mammalian cells. Additionally, because plant cells tend to be “stickier” than mammalian cells, they aggregate together during DEP sorting, a problem that is shown herein to be overcome by utilizing one or more of non-stick coated electrodes, torsional hydrodynamic forces during DEP sorting, two or more flow streams during DEP sorting, specific media and/or specific combinations of frequencies and voltage. Finally, many non-mammalian cells (such as pollen) are very sensitive and may be harmed by heat or too great a voltage applied for the media used, and so different conditions must be used than what has been used for DEP sorting of mammalian cells in order to prevent aggregation while achieving cell sorting. As such, if plant cells such as pollen were sorted using media which have been used for DEP sorting of mammalian cells, they may suffer a partial or total loss of viability.

Without wishing to be bound to a particular theory or mechanism, the plant cells are sorted using a combination of dielectric and hydrodynamic properties of the plant cells. A hydrodynamic force is exerted on the plant samples as they flow in the first flow stream. Passing current through the electrodes causes a DEP force to be exerted on the plant samples, and generates a torque that causes one type of plant sample to rotate and be transported away from the first flow stream into another flow stream, thus separating the two types of plant samples.

In some embodiments, the i.e., electrodes (125) span from a first side (111a) to an opposing second side (111b) of the first microchannel. The electrodes (125) may be disposed on a bottom surface (112) of the first microchannel. In other embodiments, the electrodes (125) are parallel to each other. The electrodes (125) may be oriented at an angle θ, ranging from about 25°-90°, relative to the first microchannel (110). In a non-limiting embodiment, θ may range from about 30°-45°.

In some embodiments, the microfluidic DEP sorting device (100) may further comprise one or more input channels (115) fluidly coupled to the first microchannel (110). For example, the device (100) may have 2-4 input channels (115). The plant cells can be introduced into the first microchannel (110) via the one or more input channels.

In other embodiments, one or more buffer fluids can also be introduced into the first microchannel (110) via the one or more input channels (115). In one embodiment, the buffer fluids are streamed into the first microchannel (110) to cause the plant samples (10) to flow in the first flow stream. In a non-limiting embodiment, the buffer fluids may comprise a sample buffer fluid and a carrier buffer fluid. The sample buffer fluid is used during sorting of the plant cells and the carrier buffer fluid is introduced after sorting of the plant cells.

According to some embodiments, the sorting region (120) further comprises at least two output channels (135) fluidly coupled to the first microchannel (110). For example, the sorting region (120) may comprise 2-4 output channels (135). The output channels (135) are downstream of the electrodes (125) and branches from the first microchannel (110).

According to other embodiments, the device (100) may comprise two or more electrode arrays (125). In one embodiment, the two or more electrode arrays (125) are disposed in series (e.g. one after the other) in the first microchannel (110). In some embodiments, the electrodes of one array may have the same spacing as the electrodes of the other array(s). Alternative, each array may have variable electrode spacing and may operate at different voltages and/or frequencies.

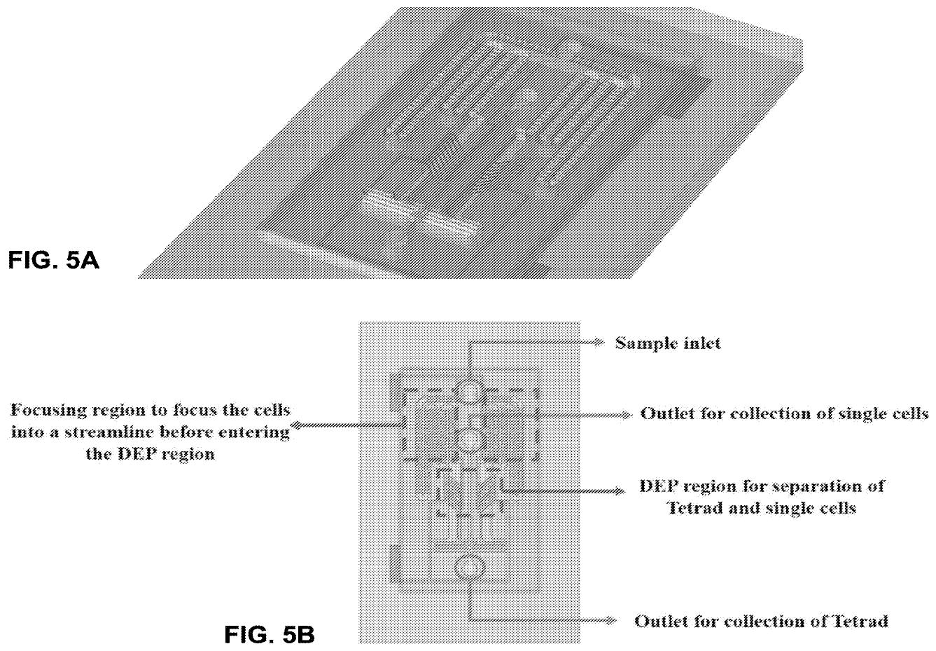

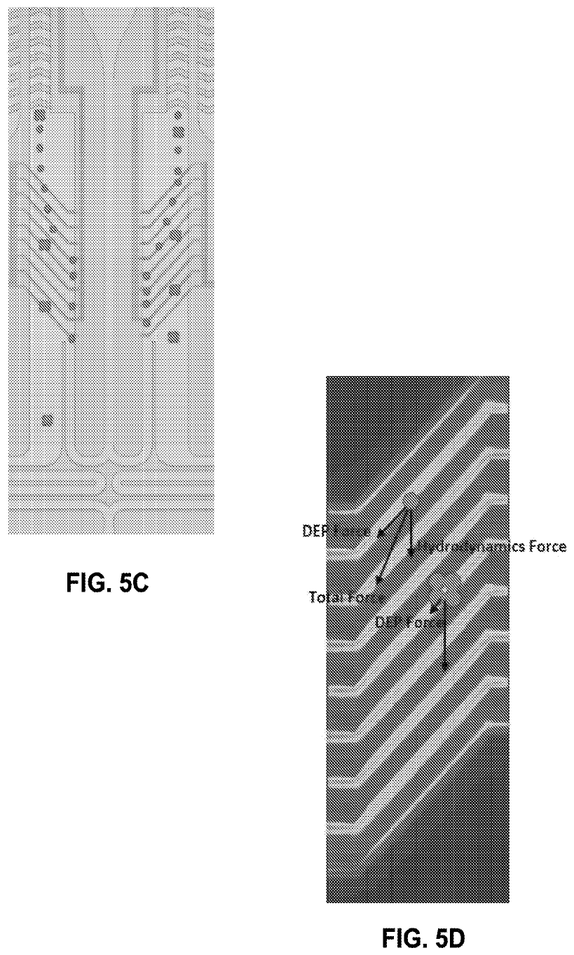

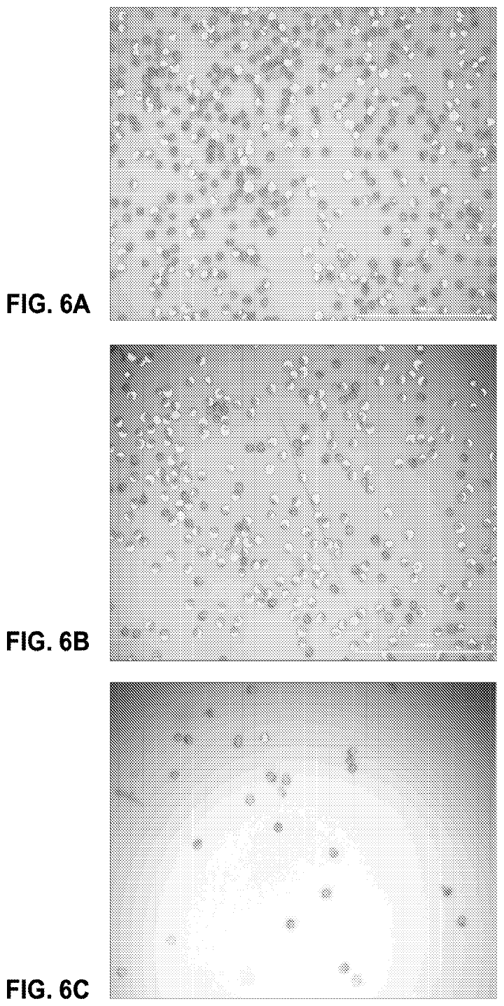

In another embodiment, the electrode arrays (125) may be disposed parallel to each other. For example, as shown in FIG. 5A, a flow channel is disposed between parallel electrode arrays (125). This embodiment may have three outputs, one for each electrode array and one for the middle flow channel. In some embodiments, the arrays may be mirror images. For instance, the electrodes of one array may be angled at θ and the electrodes of one array may be angled at −θ. In other embodiments, the electrodes of one array may have the same spacing as the electrodes of the other array. Alternative, each array may have variable spacing and the electrodes may operate at different voltages and/or frequencies. In some other embodiments, the device (100) may comprise a combination of parallel electrode arrays and electrode arrays in series.

In one embodiment, the electrode array (125) may be operatively coupled to an AC voltage function generator. In another embodiment, the electrode array (125) may be operatively coupled to a timing-adjustable intervalometer. The intervalometer is configured to interrupt or switch voltages and frequencies that pulses current through the electrodes, thereby causing DEP forces along the electrodes to be periodically removed or reduced at intervals ranging from about 0.5 second to about 20 seconds. For example, the intervalometer can turn on the voltage for about 7-10 seconds and turn off the voltage for about 0.5-2 seconds.

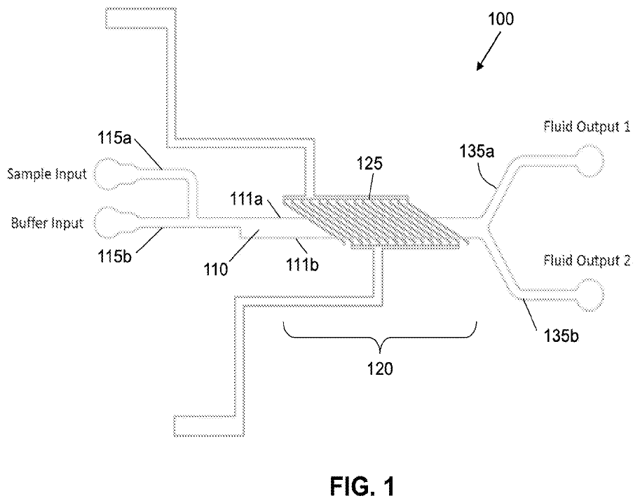

In a non-limiting embodiment, FIG. 1 shows a schematic of a microfluidic DEP sorter chip. The device may comprise two inputs: one for the sample and one for the focusing buffer, a slanted array of interdigitated electrodes, and two outputs for collection of sorted plant cells. Once the sample is introduced into the system, the plant cells can be focused near the upper sidewall of the microfluidics chip by the focusing buffer. This enables the plant cells to enter the electrode region in a single focused stream. The electrode region is responsible for sorting the plant cells.

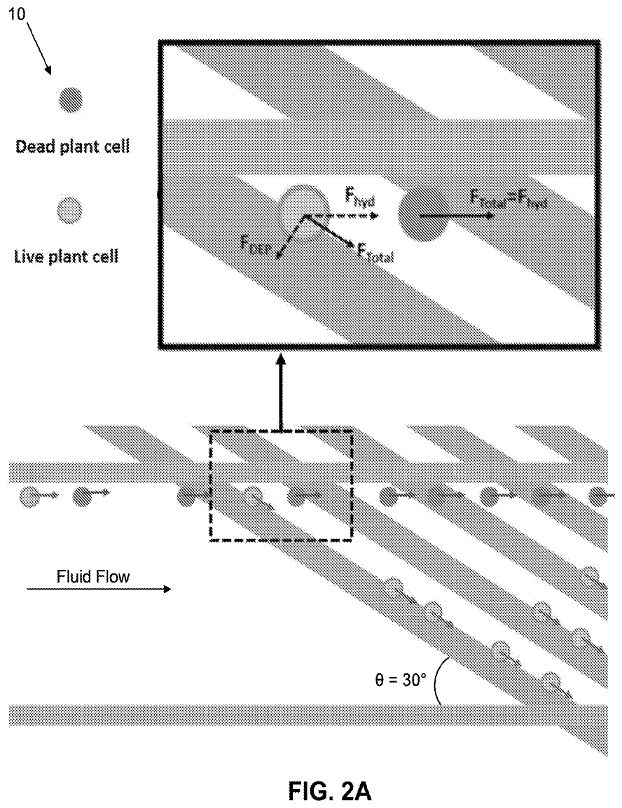

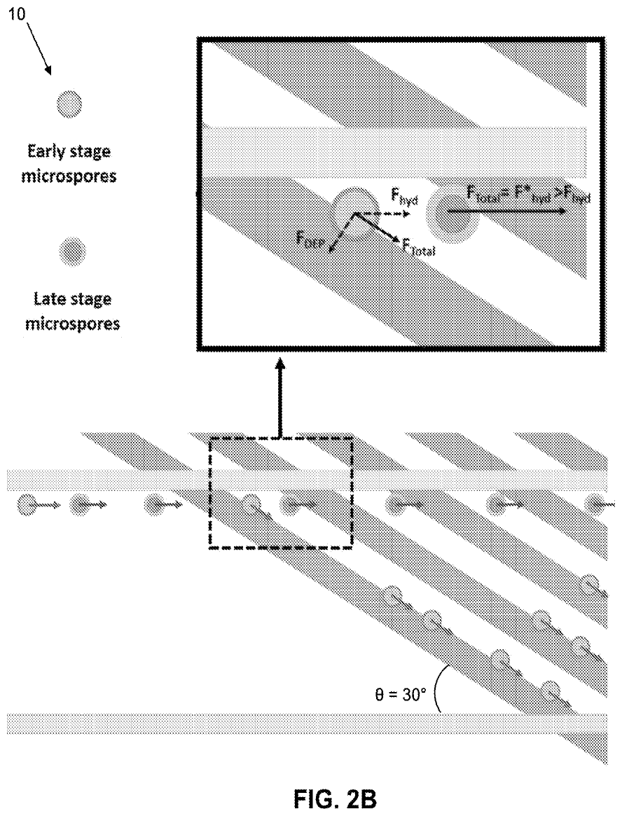

According to some embodiments, the microfluidic DEP sorter chip may be used to sort plants cells based on their level of physiological activity. For example, the plant cells may comprise live and dead plant cells (e.g. live/dead microspores or live/dead pollen cells). Referring now to FIG. 2A, sorting live and dead cells is dependent on the fact that dead cells and cells with low physiological activity experience no or very weak DEP force due to their damaged membrane. In this case, their motion in the DEP sorter is dictated only by hydrodynamics forces. On the other hand, by fixing the applied electric frequency to be in the range of about 50 to 125 kHz and peak to peak voltage between 7 to 20 volts, live cells experience positive DEP (pDEP). In this regime, the live plant cells are attracted to high electric field region near the electrode edges. As a result, the combination of hydrodynamics and DEP force can guide the live plant cells to move along the electrode edges and thus, sort and separate them from dead cells.

In some embodiments, the microfluidic DEP sorter chip may be used to sort plant cells based on their stage of development. For example, microspores at earlier stages of development may be sorted from microspores at later stages of development. Referring now to FIG. 2B, sorting live and more physiologically active microspores at different stages of development not only uses the plant cells' DEP response but also combines it with their unique hydrodynamic motion. At an applied electric frequency in the range of 50 to 125 kHz and peak to peak voltage between 7 to 20 volts, it was observed that earlier stage microspores experience relatively strong pDEP force (i.e. tend to be attracted to electrode edges) while later stage microspores experience either weak pDEP, no DEP, or even nDEP (i.e. tend to be repelled from electrodes). It was also observed that later stage microspores experience larger hydrodynamic force and thus, their trajectory is difficult to change via DEP. These two factors can allow for sorting based on the stage of developments. Without wishing to limit the present invention, by applying the aforementioned electric parameters, earlier stage cells can slide along the electrode edges while later stage cells remain in the direct flow stream without being significantly affected by the DEP force.

Unlike mammalian cells, transport of plant cells along the electrodes is a challenging task. Due to their sticky nature, it was frequently observed that the plant cells tended to stick to the electrodes. Hence, there existed a need to optimize the microfluidic sorters. The present invention has developed improvements to DEP sorting that surprisingly reduced sticking of the plant cells to the electrodes.

According to some embodiment, the electrodes of the microfluidic DEP sorter were positioned at an angle θ relative to the flow direction. In preferred embodiments, the electrodes may be positioned at an angle θ range from 25° to 90° relative to the flow direction. For example, in FIG. 2A, the electrodes of the microfluidic DEP sorter may have angled at 30°. In another example shown in FIG. 5B, the electrodes of the microfluidic DEP sorter may have angled at 45°. By positioning the electrodes at an angle, an effective rotational movement that helps the plant cells avoid sticking to the electrodes is achieved.

Without wishing to be bound to a particular theory or mechanism, angling the electrodes relative to the flow direction facilitates plant cell transport along the electrodes by increasing: i) the effective hydrodynamic force along the electrode direction, and ii) the torque and cell rotational movement while being transported along the electrodes. The latter is especially unique to plant cells where their relatively larger size compared to mammalian cells causes the hydrodynamic force to generate a significant torque that causes the cell to rotate while sliding along the electrodes.

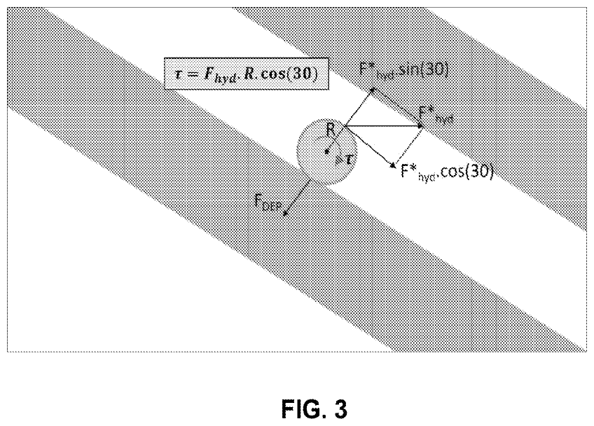

Without wishing to be bound to a particular theory or mechanism, the hydrodynamic forces on plant cells are a result of a drag force applied by the fluid on the cells. This force is proportional to the size of the cells and the flow velocity. Compared to mammalian cells, plant cells are much larger therefore they usually experience a large hydrodynamic force. Referring to FIG. 3, the generated torque, τ, is proportional to the effective hydrodynamic force, F_{hyd}, as well as the cell's radius, R, as follows: τ=F_{hyd}Rcos (30). According to Stokes' law, since the hydrodynamic force is proportional to the cell's radius, the torque that the cells experience is proportional to R². As a result, even 2-3 times increase in cell size for plant cells compared to mammalian cells results in 4-9 times increase in torque.

Moreover, the higher the flow velocity, the larger the hydrodynamic force. There are several factors that can affect the flow velocity and, consequently, the hydrodynamic force. For example, increasing the flow rates of the samples and buffer fluids increases the hydrodynamic force. With constant flow rate, increasing the channel height reduces the flow velocity and, consequently, the hydrodynamic force. With constant flow rate and channel height, increasing the width of the flow channel reduces the flow velocity and, consequently, the hydrodynamic force. Overall, the large hydrodynamic force experienced by plant cells creates a rolling effect.

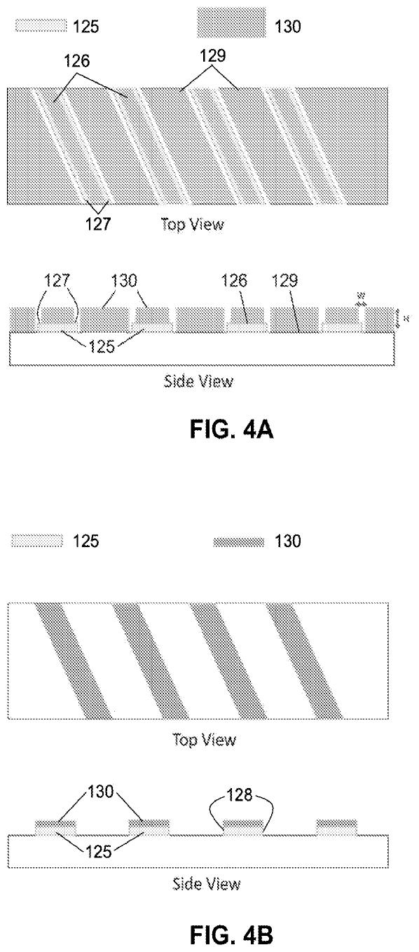

Another reason for poor plant cell transport along the electrodes is the interaction between the electrodes and the plant cells. Thus, in some preferred embodiments, the electrodes of the microfluidic DEP sorter may be coated with a non-stick insulator coating as shown in FIGS. 4A-4B. It was contemplated that completely covering the electrodes would block the electric field, making DEP manipulation impossible unless a very high electric field applied. Thus, the coating was modified to minimize the electrode-plant cells interactions while keeping the effectiveness of the electric field to deflect the cells. Instead of completely coating the electrodes, which would block the electric field entirely, the electrodes were partially coated and the remaining portions were left uncoated.

As used herein, “partially covered” or “partially coated” means that a portion of the electrode's surface is covered with the non-stick coating while a remaining portion is uncovered. For example, at least 50% of the electrode's surface is covered with non-stick coating. In other embodiments, at least 75% of the electrode's surface is covered with non-stick coating. In one embodiment, a top surface of the electrode is covered whereas the sides of the electrode are uncovered. Alternatively, only a portion of the top surface is covered and the sides may or may not be covered. The covered portion of the top surface may be the midsection or conversely, the top edges.

Referring to FIG. 4A, in one embodiment, the electrode surface and the surface between the electrodes were covered whereas the electrode edges were not covered. In this design, the non-stick coating was patterned such that there is an opening on the edges of the electrodes (similar to railroad rails). There are two main design considerations of the railroad rail partial non-stick coating embodiment: i) height of the coating (H), ii) width of the gap (W) between coatings. In some embodiments, the height of coating may range from about 5-50 μm. The higher the height, the lower the chance of the plant cells touching the electrodes. However, this would result in a reduction of the electric field strength applied on the cells. Thus, in preferred embodiments, the height may range from about 5-20 μm. In other embodiments, the width of the gap may range from 5-30 μm. The smaller the width, the lower the chance of the plant cells touching the electrodes. However, this would result in in a reduction of the electric field strength applied on the cells. Therefore, in preferred embodiments, the width of the gap may range from about 10-20 μm. Although optimum values for H and W depend on the size of cells, the aforementioned ranges may be applicable for most cells.

Referring to FIG. 4B, in another embodiment, the top of each electrode was completely covered whereas the sides of the electrodes were not covered. For this configuration, the top coating may have a thickness ranging from about 1-5 μm. In this way, the plant cells only touch the side (128) of electrodes. In some embodiments, the electrodes are sufficient spaced such that the cells can fit in between the electrodes and come into contact with their sides (128). For example, the spacing between the electrodes is greater than a maximum dimension of the cell, such as a diameter of the cell. Another advantage of this design is that it makes the rolling effect much more dominant as compared to non-coating designs. For both strategies, the effectiveness of the electric field was maintained, and the plant cells could move along the defined patterns while the plant cells-electrode interaction was minimized.

According to another embodiment, FIGS. 5A and 5B show a schematic of a DEP sorting device having two electrode arrays in the sorting region. The device comprises a sample inlet, focusing regions for focusing the cells into specific streamlines before entering the DEP sorting region, the two electrode arrays for separating the plant cells by type, and two outlets for collection of the separated cells. Separation of tetrads and single microspores was demonstrated using this embodiment of the DEP device. However, it is to be understood that tetrads and single microspores can also be sorted using the device of FIG. 1.

The sorting process at the DEP region is shown in FIGS. 5C and 5D. According to the experimental results, single plant cells experience positive DEP (pDEP) forces at high applied electric field frequencies (f=1.3 MHz). In this regime, the cells tend to be attracted toward high electric field regions at the electrode edges. The DEP region comprised two arrays of electrodes, angled at 45°, to push single cells in a lateral direction with respect to the flow field based on pDEP and consequently facilitate their separation from tetrads. The separation principle is based on the difference between the DEP and hydrodynamic forces experienced by tetrad and single cells. As single cells pass through the DEP region, the strong DEP force exerted on them by the electric field results in their lateral movement along the electrode edges. However, it has been observed that tetrads do not experience as strong DEP force as single cells and thus, they remain in the main flow streamlines caused by the hydrodynamic force. This may be due to the tetrads experiencing a weaker DEP force caused by their unique structure where four cells experience DEP forces in different directions that cancel each other out.

In some embodiments, the microfluidic DEP sorter may range from about 50-300 μm in height. For example, the height of the sorter may be 200 μm. In other embodiments, the width of microfluidic DEP sorter may range from about 500-2,000 μm. For example, the width may be about 900-1,500 μm. Without wishing to limit the present invention, the height and width of the microfluidic DEP sorter were optimized so as to result in smooth flow of large plant cells. In some embodiments, the microfluidic DEP sorter may further include a flow regulator positioned at each fluid output to control the flow of the fluid in the fluid path.

In a non-limiting embodiment, the electrodes may be constructed from 300 Å Chromium and 3000 Å Gold patterned on glass. In some embodiments, the electrodes may be about 25-50 μm wide. In another embodiment, the electrodes may be spaced about 100-200 μm apart. Alternatively, the spacing between the electrodes in an array may vary in width. The spacing of the electrodes may be determined according to the size of the plant cells. In preferred embodiments, following one application, the electrodes can be washed with water, detergent, surfactant or sterilization fluid prior to being used for a subsequent application. Table 1 shows non-limiting examples of the parameters of the DEP device. Table 2 shows non-limiting examples of the parameters of the DEP medium.

TABLE 1
DEP device ranges

| Volts Peak-to-Peak (Vpp) | Frequency | Pulsed (Sec) |
|---|---|---|
| 0-100 | 0 kHz-1.5 MHz | 0-20 |

TABLE 2
DEP device media specificity ranges

| Osmolality | Conductivity | Viscosity | |
|---|---|---|---|
| (mOsm/kg H₂O) | (uS/cm) | (cP) | pH |
| 100-3000 | 0-1,700 | 1-10 | 4-10 |
| (e.g. 600 or 500-1000 for | (e.g. 1,300-1,700, | (e.g. 1-4) | (e.g. 6-8) |
| microspores, and 1600 or | or 1-300) | | |
| 1000-2000 for pollen) | | | |

In other aspects, long sliding/exposure time to one electrode is yet another reason for non-efficient transport of the plant cells. To circumvent this, a timing-adjustable intervalometer may be integrated with the microfluidic DEP sorting chip. In one embodiment, the intervalometer may be positioned in-line between an AC voltage function generator and the electrode array on the chip to interrupt (i.e. turn on and off) or to switch between two different voltages and frequencies that pulses/cycles the current running through the electrodes. Without wishing to bind the invention to a particular theory or mechanism, the attractive DEP forces along the electrode edges is periodically removed or reduced at regular intervals to allow for release of any cells being held too tightly to the electrodes. For example, the intervalometer turns the AC voltage on and off at regular intervals in order to prevent accumulation of microspores on the electrodes. The interval may range from about 0.5 to 10 seconds. For instance, the microspores may stick to the electrodes when the AC voltage is on for about 7 seconds, and then the microspores are released when the AC voltage is turned off for 1 second.

### EXAMPLES

The following are non-limiting examples of using the microfluidic DEP sorter. The examples herein utilize maize microspores or pollen grains. It is to be understood that said examples are not intended to limit the present invention in any way. Equivalents or substitutes are within the scope of the present invention. For instance, canola or wheat plant cells may be used instead of maize.

### Example 1: Observed DEP Properties for Microspores

Testing of microspores on a characterizing chip containing DEP electrodes was performed to confirm that cells have different dielectric properties. Without wishing to limit the invention to any particular theory or mechanism, the following observations were made from videos of mixed populations of microspores placed in the characterizing chip under non-flowing (static) carrier liquid conditions and exposed to various AC frequencies and voltages:

1) Not all microspores in a mixed population respond the same to a particular voltage and frequency.

2) Individual microspores can be induced to experience pDEP, nDEP or no DEP by the different voltages and frequencies.

3) How the individual microspores respond (pDEP, nDEP or no DEP) is dependent on the frequency and changes with changing frequency.

4) At some frequencies (generally higher frequencies at >˜1 MHz), nearly all microspores can be induced to experience pDEP and be attracted toward high electric field.

5) At some frequencies (generally very low frequencies at <˜10 KHz), nearly all microspores can be induced to experience nDEP and be repelled from high electric field.

6) Voltage primarily determines the strength of the DEP response.

For DEP electrodes in non-flowing DEP devices, Table 3 summarizes the general trends in pDEP (attraction), nDEP (repulsion) and no DEP (N) for easily observed cell types in typical microspore populations. Microspore types 1-4 are in order of most metabolically active (Type 1) to least metabolically active (Type 4). The number of positive (+) signs indicate the degree pDEP effect and the number of negative (−) signs indicate the degree of nDEP effect.

TABLE 3
Microspore response to different frequencies
in a non-flowing DEP device.

| | Frequency (kHz) | | | | |
|---|---|---|---|---|---|
| Microspore Type | 50 | 75 | 100 | 500 | 1000 |
| Microspore Type 1 | + + + | + + + + | + + + + + | + + + + + | + + + + + |
| Microspore Type 2 | + | + + | + + + | + + + + | + + + + |
| Microspore Type 3 | N | + | + | + + | + + |
| Microspore Type 4 | − − | − | N | + | + |

By using non-flowing DEP devices (generally referred to as DEP “characterization” devices), the DEP responsiveness to various frequencies and voltages of individual microspores in mixed microspore populations can be determined. Said information can be used to drive a DEP sorter to handle batch variability and properly separate the microspores into distinct sub-populations. The determined frequency and voltage values, as properties of the microspores, can be used to predict the downstream behavior of individual microspores and/or populations of microspores for various purposes. DEP can be used to identify useful microspore characteristics not visible or measurable by other means.

### Example 2: Sorting of Microspores Based on Physiological Activity

In one embodiment, microspores can be sorted according to physiological activity by separating live from dead microspores. Eliminating the volume and bulk of undesired dead microspores in a population is valuable. Sorting live from dead microspores improves uniformity and consistency for downstream microspore processing. Furthermore, the presence of dead microspores in a population of microspores has been shown to be detrimental to the health and viability of the live microspores. Downstream microspore processing includes microspore embryogenesis, genomics analysis, double haploid technologies, isolations, encapsulation, and development.

Methods and Observations

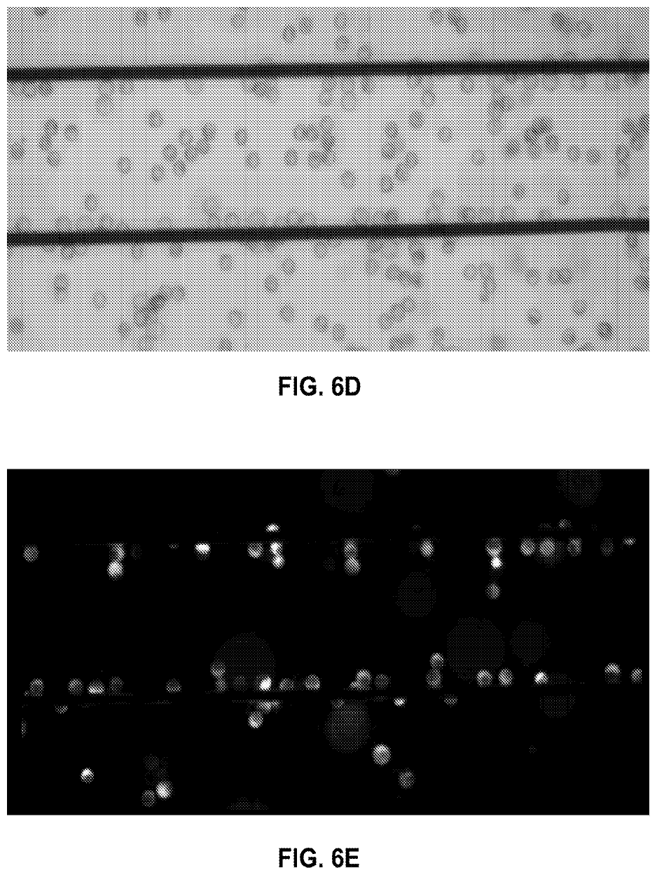

Maize tassels were staged for desired mixed population and isolated for microspores. The isolation and sorting medium had a low osmolality, low conductivity, and low pH. Following isolation, a sample of the stock microspore population was processed through a first lower voltage DEP sorter with an angled electrode array, and a separate sample was saved for pre-sorting viability observations. Additional studies were also conducted using a second higher voltage DEP sorter with a parallel electrode array. The DEP sorting parameters for the first lower voltage DEP sorter were as follows: 30 ul/min buffer input flow, 3 ul/min microspore input flow, 12 Volts Peak-to-Peak, 100 kHz, at 7 seconds on and 1 second off. The DEP sorting parameters for the second higher voltage DEP sorter were as follows: 15 ul/min buffer input flow, 5 ul/min microspore input flow or using gravity flow, 30 Volts Peak-to-Peak, 500 kHz, at 7 seconds on and 1 second off. The results of the first lower voltage DEP sorter are described below and shown in FIGS. 6A-6C, while the results of the second higher voltage DEP sorter are described below and shown in FIGS. 6D-6E. Both DEP chips were successful, showing that successful microspore DEP sorting can occur at different voltage levels, different frequencies and different electrode configurations.

Referring to FIGS. 6A-6C, after sorting through the first lower voltage DEP sorter, samples were collected from output 1 and output 2 and stained with Fluorescein diacetate (FDA) to measure metabolic activity as an indicator of viability. In addition, the pre-sorted sample was also FDA stained and observed. Observations were made on the Lionheart FX (LED:10/Exposure:200/ Gain:12). Pre-sorted sample stained with FDA had a viability of 56%. For output 1, the viability was enriched to 87% and for output 2, the viability was 8%.

The results of the second higher voltage DEP sorter are shown in FIGS. 6D-6E Prior to application of the DEP field, microspores were evenly distributed across the chip and were neither attracted nor repelled from the electrodes. FIG. 6D demonstrates attraction of cells to electrodes resulting from application of a DEP field at 30 Volts Peak-to-Peak 500 kHz, with live cells concentrated on the surface of the electrodes. Dead cells were repelled from the electrodes and accumulated between the electrodes. FIG. 6F demonstrates green fluorescence produced by Florecine Diacetate Staining (FDA) of cells, indicating majority of live/viable cells attracted to the electrodes.

### Example 3: Sorting a Mixed Population of Tetrad and Individual Microspores

In another embodiment, a mixed population of microspores can be sorted based on formation type. In this example, a mixed population of tetrad and individual microspores was collected and sorted. The downstream process that benefits from sorting based on microspore stage is double haploid technology, sequencing technology, and other downstream microfluidic based technologies.

Methods and Observations

Maize tassels from one plant were selected 50 days following planting to use for isolations. Anthers from 1-3 spikelets were excised and crushed with forceps into 100 uL of 0.6M mannitol medium in a well from an untreated 96-well culture plate. This process was repeated with spikelets throughout the tassel. Wells were scored for developmental stage by observing with an inverted microscope. Wells containing tetrads were pooled together and filtered through a 70 uL cell strainer. The flow-through was collected and run through the DEP device. The first lower voltage DEP chip was used, and DEP sorting parameters were as follows: 3.4 ul/min microspore sample input flow, 10-13 Volts Peak-to-Peak, 1.3 MHz, no pulsing.

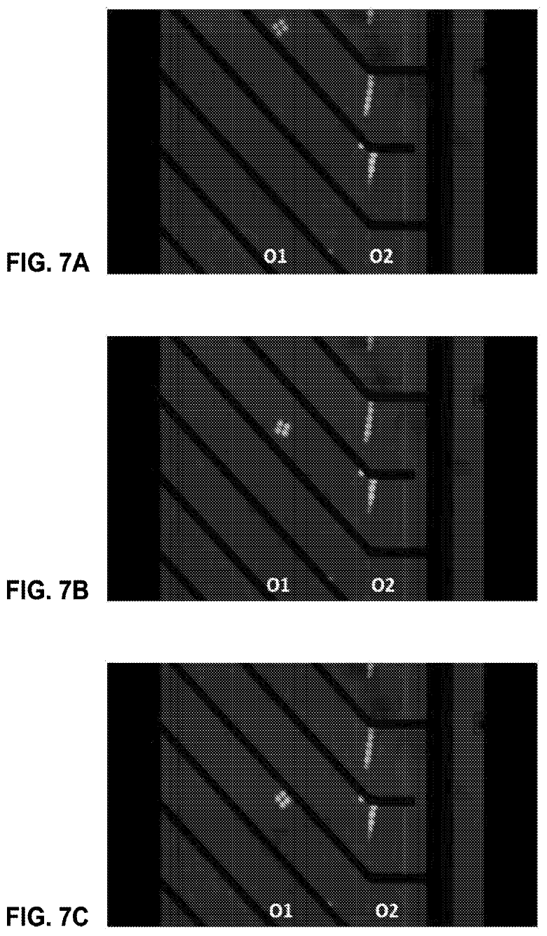

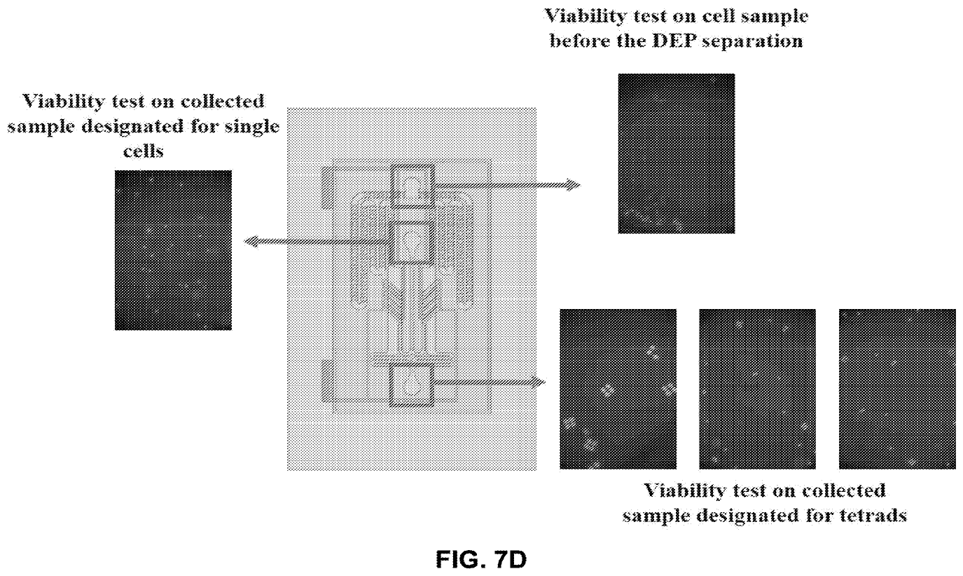

FIG. 7A-7C demonstrates the separation of tetrads from single microspores. After sorting, samples were collected from a centrally-located output for capturing tetrads and a far right-located output for capturing single microspores.

Referring to FIG. 7D, viability of isolated tetrads after exposure to the electric field is an important aspect that was evaluated. For this purpose, Calcein Blue AM staining was performed on the collected sample from designated outlets. The cells were then incubated in the dark at room temperature for 15 minutes. For better comparison, the same staining protocol was applied to the cell sample before the separation process as well. The results show that the DEP device can enrich tetrad cells without adversely affecting their viability, thereby confirming the feasibility of such technique for sorting.

### Example 4: Sorting a Cell Population Composed of Microspores at Different Developmental Stages

Microspore developmental stages vary in their ability to be responsive to various types of chemical, gene regulators, and environmental stimuli. Such stimuli, if provided at a certain developmental stage, can induce and promote a desired developmental pathway in the microspores, such as increasing in size, forming multi-cellular structures (e.g. microcalli) or forming embryo-like cellular structures. As such, selecting and separating microspores that are at the optimal developmental stage for such activation is desired.

In a non-limiting embodiment, a mixed population of microspores at different developmental stages, early uninucleate vs. late uninucleate microspores, was collected and sorted. The downstream processes that can benefit from sorting based on microspore developmental stage are doubled haploid generation, plant regeneration, gene activation analysis, RNA analysis, protein expression analysis, and other downstream microfluidic-based single cell manipulation technologies.

Methods and Observations

Maize tassels of an appropriate stage were selected to contain desired microspore developmental stages. Microspores were isolated from these tassels. The isolation and sorting medium had low osmolality, low conductivity, and low pH. Following isolation, a subsample of the microspore population was processed through the DEP sorter. The DEP sorting parameters were as follows: 30 ul/min buffer input flow, 3 ul/min microspore input flow, 12 Volts (peak-to-peak), 100 kHz, pulsed at 7 seconds on and 1 second off.

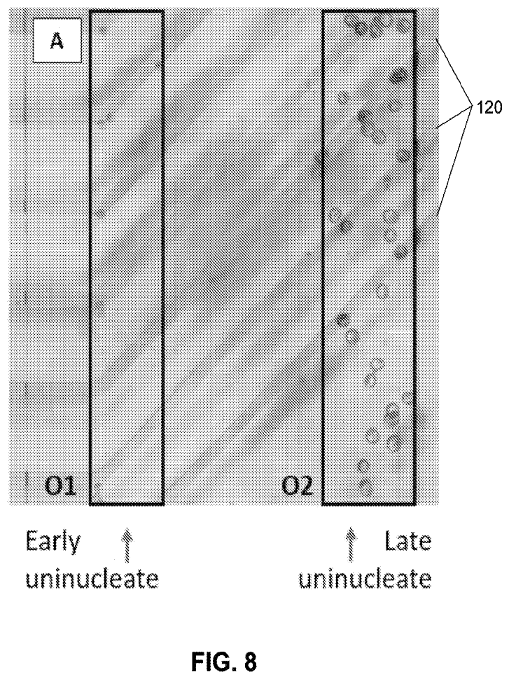

FIG. 8 illustrates the observed DEP separation of early uninucleate from late uninucleate microspores. After DEP separation, each sub-population was collected at the two output ports of the sorter. Early uninucleate microspores exited through output 1 (O1) and late uninucleate microspores exited through output 2 (O2).

### Example 5: Sorting a Mixed Population of Cultured Microspores, microspore-Derived Multi-Cellular Structures, or Microspore-Derived Embryo-Like Structures.

Canola buds were staged for desired mixed population and isolated for microspores. Following isolation, the canola microspore population was changed to culturing medium for 7 days. Prior to sorting the microspore population was changed to sorting medium made of low osmolality, low conductivity, and low pH. The population was processed through a DEP sorter with a diamond design electrode array. The DEP sorting parameters for the lower voltage DEP sorter were as follows: no flow applied 40-50 Volts Peak-to-Peak, 1.2 kHz, observation of embryogenic cells attraction to electrodes versus non-developing cells. This mixed cell population, will contain non-responsive cells, large responsive single cell microspores, microspore-derived multi-cellular structures, as well as embryo-like cellular structures, and will be processed through the DEP sorter. The desired cell activity, multi-cellular or embryo-like structure will be separated and collected based on the unique DEP signature properties of the desired cells. This method provides an automated means of sorting and isolating the desired cells without the need for manual cell-picking operations.

### Example 6: Observed DEP Properties for Pollen

Testing of pollen on a characterizing chip containing DEP electrodes was performed to confirm that pollen grains have different dielectric properties. Without wishing to be limit the invention to a particular theory or mechanism, the following observations were made from videos of mixed populations of pollen placed in the characterizing chip under non-flowing (static) carrier liquid conditions and exposed to various AC frequencies and voltages:

1) Not all pollen in a mixed population responds the same to a particular voltage and frequency.

2) Individual pollen grains can be induced to experience DEP vs no DEP by the different voltages and frequencies.

3) How the individual pollen grains respond to DEP vs no DEP is dependent on the frequency and changes with changing frequency.

4) At some frequencies (generally higher frequencies at >˜1 MHz) nearly all pollen grains can be induced to be experience pDEP and attracted toward high electric field.

5) At some frequencies (generally very low frequencies at <˜100 KHz) nearly all pollen grains can be induced to be experience nDEP and repelled from high electric field.

6) Voltage primarily determines the strength of the DEP response.

For DEP electrodes in non-flowing DEP devices, Table 4 summarizes the general trends in pDEP (attraction), nDEP (repulsion) and no DEP (N) for easily observed cell types in typical pollen populations. Positive (+) values for the relative DEP effect indicate the degree pDEP and negative (−) values indicate the degree of nDEP.

TABLE 4
Pollen response to different frequencies
in a non-flowing DEP device.

| | Frequency (kHz) | | |
|---|---|---|---|
| Pollen Type | 100 | 500 | 1000 |
| Pollen Type 1 (Live) | −/+ | + + | + + + |
| Pollen Type 2 (Intermediate) | −/+ | + | ++ |
| Pollen Type 3 (Dead) | − | N | + |

By using non-flowing DEP devices (generally referred to as DEP “characterization” devices), the DEP responsiveness to various frequencies and voltages of individual pollen in mixed pollen populations was determined. Said information can be used to drive a DEP sorter to handle batch variability and properly separate the pollen into distinct sub-populations.

Through the use of DEP, the determined frequency and voltage values, as properties of the pollen, can be used to identify useful pollen characteristics not visible or measurable by other means.

### Example 7: Sorting Pollen Grains Based on Physiological Activity

As indicated by the characterization in Example 6, DEP can be successfully used for sorting live pollen grains from dead pollen grains. In this example, the downstream process that benefits from the removal of the dead pollen grains is the maximization of successful pollination, because the presence of dead pollen grains in a population of pollen is biologically detrimental to the population.

Methods and Observations

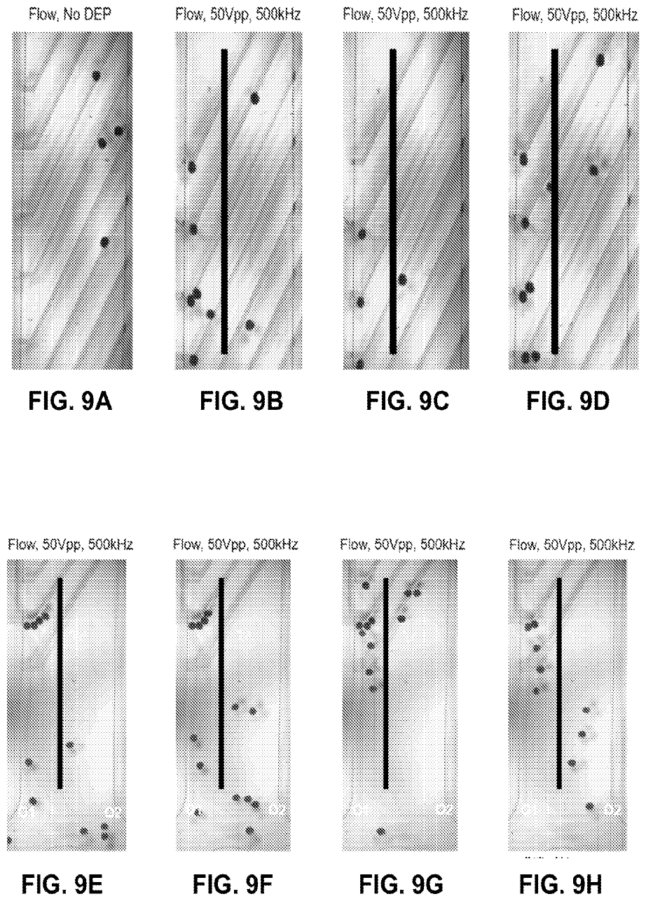

Pollen was collected from actively shedding maize tassels and added to pollen sorting media. The media had a low osmolality, low conductivity, and high pH aqueous media. The DEP sorting parameters are as follows: DEP field at 2 ul/min buffer input flow, 14 ul/min microspore input flow, 50 Volts Peak-to-Peak, 500 kHz, at 7 seconds on and 1 second off. FIG. 9A illustrates the observed direction of pollen with no DEP field. Pollen continued along the right side of the entire chip exiting through output 2 (O2). FIGS. 9B-9H illustrate the direction of mix pollen within the DEP field. Viable pollen under DEP field attracts towards electrodes and are additionally push due to hydrodynamic forces towards the left side of the chip past the added flow line exiting through output 1 (O1). Pollen cells which do not pass the flow line are not greatly influence by DEP and exit on the right side of the chip through output 2 (O2).

### Example 8: Demonstration of Pollen Germination After Impose DEP Force, Indicating Non-Destructive DEP

A vital characteristic of pollen functionality is the formation of pollen tubes to deliver nuclei, and it is essential for a successful fertilization.

Methods and Observations

Pollen was collected from actively shedding maize tassels and added to storage medium. Storage consists of a high osmolality, low conductivity, high pH aqueous medium. Following isolation, a representative subsample of the stock pollen suspension was processed through DEP field (60 Vpp, 500 kHz) and observations are made across multiple sample replicates. Second subsamples of stock replicates were included as positive controls. In addition to the fresh and positive controls, non-viable and negative controls were also included.

Fresh pollen not exposed to the DEP field was transferred to germination medium and measured for % germination at 22.6±0.7. Samples of fresh pollen exposed to the DEP field were transferred to germination medium and measured for % germination at 21.7±3.6. Non-viable pollen samples were transferred to germination medium and measured for % germination at 0. Negative fresh control samples were kept at in storage medium and measured for % germination at 0. Transfer of pollen from one medium to another was accomplished by centrifugation to pelletize the pollen.

TABLE 5
Pollen germination rates after 5 Hour DEP Assay

| | 5 Hour Assay | | | |
|---|---|---|---|---|
| Sample | Rep1 | Rep2 | Rep3 | % Germination |
| Fresh no DEP | 79/352 | 57/244 | 84/381 | 22.6 ± 0.7 |
| Fresh w/DEP | 11/62 | 24/107 | 29/117 | 21.7 ± 3.6 |
| Non-Viable | 0 | 0 | 0 | 0 |
| Negative Fresh | 0 | 0 | 0 | 0 |

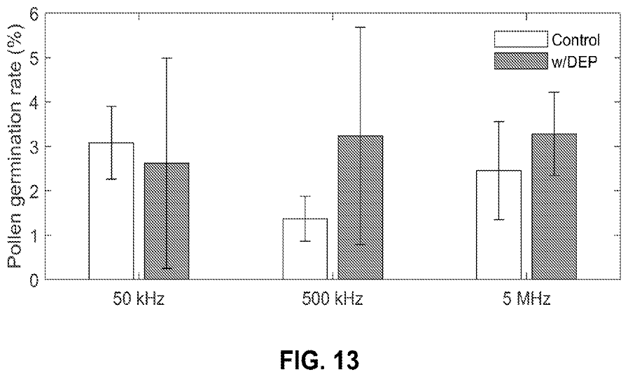

The germination rate of pollen grains was evaluated for three DEP signals of different frequencies spanning two orders of magnitude (FIG. 13). As control, fresh pollen not exposed to the DEP field was suspended in storage media and transferred to germination media to measure is germination rate after 5 hrs. Pairwise comparison between controls and samples was performed after application of the DEP signal to eliminate confounding factors related to time elapse; additionally, DEP application order was randomized to further eliminate confounding factors. Control samples showed germination rates between 1.6-3.1%, while DEP-treated pollen 2.6-3.3% (FIG. 13).

### Example 9: Sorting a Mixed Cultured Population of Non-Responding and Responding Microspores

After microspores were isolated from maize tassels, they are placed in specific culture medium for up to 3 weeks. Some of the microspores respond to the culture treatment (as described in Example 5) and increase in size to greater than 70 μm. This mixed cell population, containing non-responsive cells (low viability) and responsive larger single cell microspores (high viability), is processed through the DEP sorter. The desired responding cells are separated and collected based on the unique DEP signature properties. This method provides an automated means of sorting and isolating the desired cells without the need for manual cell-picking operations.

Methods and Observations

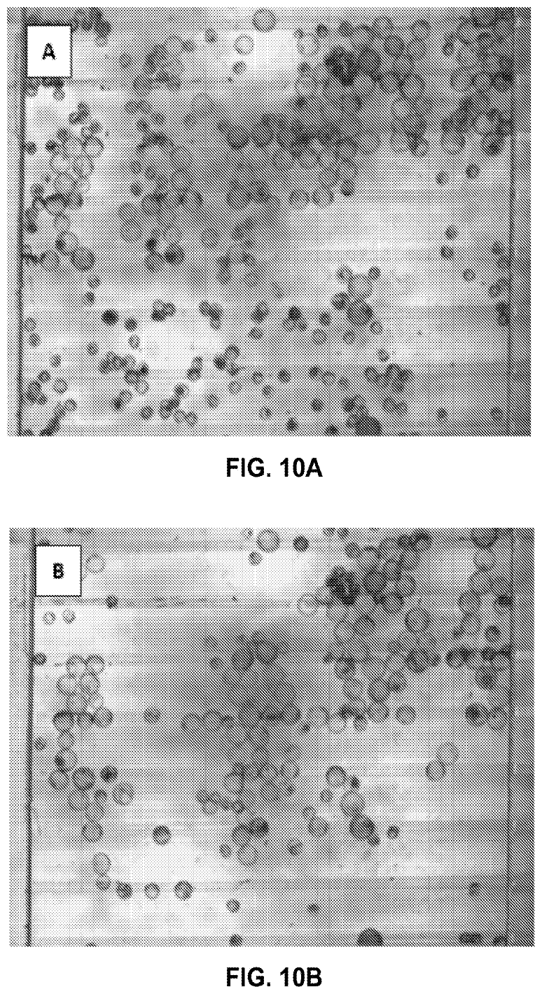

Maize tassels are selected and isolated for desired microspores. The population of maize microspores is then treated for up to 3 weeks with culture medium that stimulates cell division. After a period of treatment time, the treatment medium is replaced with a sorting medium and the mixed cell population is passed through the DEP sorter to select for desired cell subgroups. The DEP sorting parameters are as follows: 15 ul/min microspore input flow, 11 Volts (peak-to-peak), 1.3 MHz, with no pulsing. FIG. 10A demonstrates the beginning of run with flow and DEP and FIG. 10B demonstrates the end of the run only having responding cells attach to the electrodes.

### Example 11: Effect of DEP Sorting on Microspore Viability

One advantage of sorting of microspores using DEP is that it does not require dyes, tags, or other chemical additives, which can have negative side effects on microspore viability and cell and plant development. As such, the resulting output sub-populations from a DEP sorter can subsequently be used for downstream processing without negative effects of these dyes, tags or other chemical additives. Other microspore downstream processes that benefit from non-destructive sorting include tissue culture, plant regeneration, sequencing, microspore-derived double haploid technologies, and manipulation.

Methods and Observations

Maize tassels are staged for desired mixed population and isolated for microspores. The isolation and sorting medium have low osmolality, low conductivity, and low pH. Following isolation, a sample of the stock microspore population is processed through the DEP sorter and a separate sample is saved for pre-sorting viability observations. After sorting, samples are collected from output 1 and output 2, combined, and stained with Fluorescein diacetate (FDA) to measure metabolic activity as an indicator of viability. In addition, the saved pre-sorted sample may also be FDA stained and observed. Pre-sorted sample stained with FDA stained for percentage viability are compared to the percentage viability of the combined outputs.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited herein are solely for ease of examination of this patent application, are exemplary, and not intended in any way to limit the scope of the claims to the particular features having the corresponding reference numbers in the drawings. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. A non-invasive method of soiling non-mammalian samples from a mixture of at least two types of non-mammalian samples, the method comprising:
a) providing a microfluidic dielectrophoresis (DEP) sorting device comprising:
i. a first microchannel; and
ii. a sorting region comprising at least one array of electrodes;
b) providing a fluid suspension comprising the samples;
c) flowing the fluid suspension in the first microchannel such that the samples flow in a first flow stream; and
d) passing a current through the electrodes at a selected frequency, thereby causing a DEP force to be exerted on the samples;
wherein the DEP force causes one type of sample to be transported away from the first flow stream into another flow stream, thus separating the two types of samples.

2. (canceled)

3. The method of claim 1, wherein at least one type of sorted sample is doubled, germinated, sequenced, or cultured after soiling.

4. The method of claim 1, wherein at least one type of sample from the mixture is pollen, and the pollen retains viability through the sorting process.

5. The method of claim 1, additionally comprising identifying a frequency which provides for effective separation of the at least two types of samples, and using that frequency as the selected frequency.

6. The method of claim 5, wherein the frequency which provides for effective separation is identified by observing a relative response of each of the at least two types of samples to a variety of frequencies.

7. The method of claim 1, wherein the selected frequency is configured to cause a negative DEP response or a positive DEP response.

8-35. (canceled)

36. A microfluidic dielectrophoresis (DEP) sorting device for sorting cells, said device comprising:
a) a first microchannel; and
b) a sorting region comprising at least one array of electrodes disposed in the first microchannel, wherein at least one electrode is partially covered with a non-stick coating in order to minimize interactions between the electrodes and cells while maintaining a sufficient electric field to sort the cells,

37. (canceled)

38. The microfluidic DEP sorting device of claim 36, wherein the non-stick coating covers a top surface of the electrode, wherein each side of the electrode remains uncovered.

39. The microfluidic DEP sorting device of claim 36, wherein a surface between neighboring electrodes is covered with the non-stick coating.

40. The microfluidic DEP sorting device of claim 36, further comprising one or more input channels fluidly coupled to the first microchannel.

41. (canceled)

42. The microfluidic DEP sorting device of claim 40, wherein the cells are introduced into the first microchannel via the one or more input channels.

43. The microfluidic DEP sorting device of claim 40, wherein one or more buffer fluids are introduced into the first microchannel via the one or more input channels.

44. The microfluidic DEP sorting device of claim 43, wherein the buffer fluids comprise a sample buffer fluid and a carrier buffer fluid, wherein the sample buffer fluid is used to introduce the cells into the device, wherein the carrier buffer fluid is used to provide hydrodynamic force and generate a laminar flow stream.

45. The microfluidic DEP sorting device of claim 36, wherein the sorting region further comprises at least two output channels fluidly coupled to the first microchannel, wherein the output channels are downstream of the electrodes and branches from the first microchannel.

46-47. (canceled)

48. The microfluidic DEP sorting device of claim 36, comprising two or more electrode arrays disposed parallel to each other in the first microchannel.

49. The microfluidic DEP sorting device of claim 48, wherein a flow channel is disposed between the parallel electrode arrays.

50. (canceled)

51. The microfluidic DEP sorting device of claim 36, wherein the electrode array is operatively coupled to an AC voltage function generator.

52. The microfluidic DEP sorting device of claim 36, further comprising a timing-adjustable intervalometer operatively coupled to the electrode array, wherein the intervalometer is configured to interrupt or switch voltages and frequencies that pulses current through the electrodes, thereby causing DEP forces along the electrodes to be periodically removed or reduced at intervals.

53-71. (canceled)

72. The method of claim 1, wherein the non-mammalian samples are plant cells, wherein the plant cells are microspores, pollen, tetrads, embryos, microcalli, multicellular structures derived therefrom, or a combination thereof

73. The microfluidic DEP sorting device of claim 36, wherein the cells are plant cells, wherein the plant cells are microspores, pollen, tetrads, embryos, microcalli, multicellular structures derived therefrom, or a combination thereof.
